(19) United States
(12) Patent Application Publication
(10) Pub. No.: US 2010/0040991 A1
(43) Pub. Date: Feb. 18, 2010

(54) IN-LINE ANNEALING APPARATUS AND METHOD OF ANNEALING SUBSTRATE USING THE SAME

(75) Inventors: Yun-Mo CHUNG, Yongin-city (KR); Ki-Yong Lee, Yongin-city (KR); Min-Jae Jeong, Yongin-city (KR); Jong-Won Hong, Yongin-city (KR); Heung-Yeol Na, Yongin-city (KR); Eu-Gene Kang, Yongin-city (KR); Seok-Rak Chang, Yongin-city (KR)

Correspondence Address: STEIN MCEWEN, LLP, 1400 EYE STREET, NW, SUITE 300, WASHINGTON, DC, 20005, US

(73) Assignee: Samsung Mobile Display Co., Ltd., Yongin-city (KR)

(21) Appl. No.: 12/539,187

(22) Filed: Aug. 11, 2009

(30) Foreign Application Priority Data
Aug. 12, 2008 (KR) 10-2008-0079003

(51) Int. Cl. F27D 15/02

(52) U.S. Cl. 432/1; 432/77

(57) ABSTRACT

An in-line annealing apparatus and a method of annealing a substrate using the in-line annealing apparatus in which a plurality of heating devices provide a transportation path of a substrate and heat the substrate transported along the transportation path to a crystallization temperature, and an instantaneous high-temperature annealing unit heats the substrate positioned in the transportation path between the heating devices to a instantaneous annealing temperature. The in-line annealing apparatus and the method of annealing a substrate using the same provide a highly efficient annealing process that can be performed at various temperatures including a high temperature of 700° C. or higher.

### CROSS-REFERENCE TO RELATED APPLICATIONS

This application claims the benefit of Korean Patent Application No. 2008-79003, filed Aug. 12, 2008, the disclosure of which is hereby incorporated herein by reference in its entirety.

### BACKGROUND OF THE INVENTION

1. Field of the Invention

Aspects of the present invention relates to in-line annealing apparatus, and more particularly, to in-line annealing apparatus capable of stably annealing a substrate at a temperature of 700° C. or higher and a method of annealing a substrate.

2. Description of the Related Art

In general, according to a method of fabricating a thin film transistor (TFT) used in a flat-panel display, such as an organic light-emitting diode (OLED) display or liquid crystal display (LCD), amorphous silicon is deposited on a transparent substrate, such as glass or quartz, the amorphous silicon is dehydrogenated, impurities for forming a channel are ion-injected into the dehydrogenated amorphous silicon, the amorphous silicon is annealed to crystallize the amorphous silicon into a polycrystalline silicon, and the polycrystalline silicon is patterned into a semiconductor layer.

The semiconductor layer including source, drain, and channel regions of a TFT is formed by depositing an amorphous silicon layer on a transparent substrate, such as glass, using chemical vapor deposition (CVD). Subsequently, the amorphous silicon layer, which has low electron mobility, is annealed, thereby performing a crystallization process for forming a polycrystalline silicon layer, which has a crystalline structure having high electron mobility.

Various crystallization methods may be used to crystallize the amorphous silicon into the polycrystalline silicon. However, the methods are similar in that energy, i.e., heat, is applied to the amorphous silicon to crystallize the amorphous silicon into polycrystalline silicon. In order to apply heat to the amorphous silicon, a method of introducing a substrate into a furnace and heating the amorphous silicon using a heater of the furnace is most frequently used.

FIG. 1 illustrates conventional annealing apparatus. A method of annealing amorphous silicon using a conventional furnace will be described with reference to FIG. 1. The conventional furnace is a batch-type annealing apparatus that may include a substrate 101 to be heated, a support 102 to support the substrate 101 while in the furnace, and a heating body 103 to heat the substrate 101. The substrate 101 is introduced into the batch-type annealing apparatus using a robot arm (not shown). Here, the substrate 101 introduced by the robot arm is put on the support 102.

Subsequently, when amorphous silicon formed on the substrate 101 is heated by the heating body 103 so as to crystallize the amorphous silicon, the substrate 101 is also heated and much damage is incurred. In particular, the substrate 101 may be large sheets of glass to be used in flat-panel displays, such as OLED displays, but the substrate 101 bends by a specific distance H due to heat as illustrated in FIG. 1.

The conventional batch-type annealing apparatus can prevent formation of a native oxide layer, etc., and generation of a particle, etc. However, it is difficult to maintain a uniform temperature between stacked substrates and a surface temperature of each substrate in the heating, crystallization, and cooling. Therefore, according to the conventional art, a time required to manufacture a substrate increases, and the substrate is deformed.

FIG. 2 is a block diagram of conventional in-line annealing apparatus. In the conventional in-line annealing apparatus, a plurality of annealing furnaces 200 are arranged in a specific form. The in-line annealing apparatus transports a substrate to the respective annealing furnaces 200 in sequence, thereby annealing each substrate.

The in-line annealing apparatus can maintain a uniform temperature and reduce a processing time in an annealing process, and also process a large-sized substrate. However, the in-line annealing apparatus has problems of an atmospheric pressure process, a sudden drop in temperature according to steps, a large installation area, and so on.

In addition, the temperature of spaces 210 between the annealing furnaces 200 is lower than the annealing temperature of the annealing furnaces 200, and thus the temperature of a substrate may fall to a deformation temperature or below.

As illustrated in FIG. 3, a substrate is annealed at a temperature T in section \textcircled{1} of the annealing furnaces 200, but the temperature falls lower the temperature T in section \textcircled{2} as the substrate moves through the space 210 to the subsequent annealing furnace 200. Therefore, when the temperature of a substrate temporarily falls to an annealing temperature or below while an annealing process is performed as illustrated in FIG. 3, the substrate is deformed.

### SUMMARY OF THE INVENTION

Aspects of the present invention provide in-line annealing apparatus that can prevent the temperature of a substrate from falling while passing between heating devices disposed in a line and, thus, can prevent a large-sized substrate from being deformed, and a method of annealing a substrate using the in-line annealing apparatus.

Aspects of the present invention also provide an in-line annealing apparatus that rapidly anneals a substrate above the deformation temperature of the substrate between heating devices through which the substrate is transported and thus can increase crystallinity through high-temperature annealing, which is the main factor of polysilicon crystallinity, and a method of annealing a substrate using the in-line annealing apparatus.

Aspects of the present invention also provide in-line annealing apparatus that heats a substrate to a preliminary heating temperature while transported along a transportation path, again heats it to a crystallization heating temperature, cools it in stages, and thus can maintain characteristics of silicon annealed at a high temperature and prevent the substrate from being deformed by sudden cooling, and a method of annealing a substrate using the in-line annealing apparatus.

According to an embodiment of the present invention, an in-line annealing apparatus includes: a plurality of heating devices that provide a transportation path along which a substrate moves to heat the substrate to a crystallization temperature; and an instantaneous high-temperature annealing unit disposed between two of the plurality of heating devices in the transportation path to heat the substrate to a instantaneous annealing temperature while the substrate is moved along the transportation path to an adjacent heating device.

According to an aspect of the present invention, the instantaneous high-temperature annealing unit may include: a plurality of heat sources disposed to heat the transported substrate to the instantaneous annealing temperature; and a controller to control operation of the heat sources.

According to an aspect of the present invention, the instantaneous annealing temperature may be set higher than the crystallization temperature.

According to an aspect of the present invention, the heat source may be an ultraviolet (UV) light source emitting UV light.

According to an aspect of the present invention, the UV light may have a short wavelength.

According to an aspect of the present invention, the crystallization temperature is about 600-700° C.

According to an aspect of the present invention, the instantaneous annealing temperature is about 700° C. or higher.

According to an aspect of the present invention, the substrate may be heated at the crystallization temperature longer than heated at the instantaneous annealing temperature.

According to an aspect of the present invention, the in-line annealing apparatus may further include: a preliminary heating device disposed on one end of the heating devices to provide a substrate entry path connected to the transportation path and to maintain the substrate at a preliminary heating temperature lower than the crystallization temperature before the substrate enters the heating devices; and a plurality of follow-up cooling devices disposed on the other end of the heating devices to provide a substrate exit path extending from the transportation path to maintain the substrate at cooling temperatures lower than the crystallization temperature upon exit of the substrate from the heating devices.

According to an aspect of the present invention, the cooling temperatures of the respective follow-up cooling devices may be determined to be a middle temperature of cooling temperatures of follow-up cooling devices into which the substrate has been introduced and not introduced with respect to a follow-up cooling device in which the substrate is positioned to be cooled, or a middle temperature between the crystallization temperature of the heating devices and the cooling temperatures of the follow-up cooling devices.

According to an aspect of the present invention, the in-line annealing apparatus may further include: buffers disposed between the preliminary heating device and the heating devices, between the heating devices and the follow-up cooling devices and between the follow-up cooling devices to transport the substrate, and a time for transporting the substrate through the buffers may be shorter than a time for transporting the substrate through the instantaneous high-temperature annealing section.

According to another embodiment of the present invention, a method of annealing a substrate using in-line annealing apparatus includes: heating, using a preliminary heating device, a substrate introduced through a substrate entry path to a preliminary heating temperature; repeatedly heating, using a plurality of heating devices and instantaneous high-temperature annealing units disposed between the heating devices, the substrate transported along a transportation path connected with the substrate entry path to a plurality of temperatures higher than the preliminary heating temperature; and cooling, using a follow-up cooling device, the substrate transported along a substrate exit path connected with the transportation path in stages to a temperature lower than the preliminary heating temperature.

According to an aspect of the present invention, the repeatedly heating may include: heating, using the heating devices, the substrate to a crystallization temperature higher than the preliminary heating temperature; and heating, using the instantaneous high-temperature annealing units, the substrate positioned in the transportation path between the heating devices to an instantaneous annealing temperature higher than the crystallization temperature.

According to an aspect of the present invention, the instantaneous high-temperature annealing units may receive power from outside and heat the transported substrate to the instantaneous annealing temperature using a heat source disposed in a plurality of instantaneous high-temperature annealing apparatuses disposed between the heating devices along the transportation path.

According to an aspect of the present invention, the heating devices may constitute a crystallization heating section in which the substrate is heated to the crystallization temperature for a specific time along the transportation path, and the instantaneous high-temperature annealing apparatuses may provide an instantaneous high-temperature annealing section in which the substrate is heated to the instantaneous annealing temperature for a specific time along the transportation path between the heating devices. Here, the time of the crystallization heating section may be longer than the time of the instantaneous high-temperature annealing section.

According to an aspect of the present invention, the heating may further include: heating, using the preliminary heating device disposed on one end of the heating devices and providing the substrate entry path to be connected to the transportation path, the substrate introduced from outside to the preliminary heating temperature lower than the crystallization temperature; and cooling, using the plural follow-up cooling devices disposed on the other end of the heating devices and providing the substrate exit path extending from the transportation path, the substrate taken out to the substrate exit path to cooling temperatures lower than the crystallization temperature by specific values in stages.

According to an aspect of the present invention, the method may further include: transporting the substrate between the preliminary heating device and the heating devices, between the heating devices and the follow-up cooling devices and between the follow-up cooling devices, via buffers, wherein a time for transporting the substrate through the buffers shorter than a time for transporting the substrate through the instantaneous high-temperature annealing section by a specific value.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 illustrates conventional batch-type annealing apparatus;

FIG. 2 is a block diagram of conventional in-line annealing apparatus;

FIG. 3 is a graph showing a temperature profile according to time for annealing a substrate in the conventional in-line annealing apparatus of FIG. 2;

FIG. 4 is a block diagram of in-line annealing apparatus according to an exemplary embodiment of the present invention;

FIG. 5 illustrates an instantaneous high-temperature annealing apparatus of FIG. 4;

FIG. 6 is another block diagram of the in-line annealing apparatus of FIG. 4;

FIG. 7 is a graph showing a temperature profile according to time for annealing a substrate in the in-line annealing apparatus of FIG. 4;

FIG. 8 is a block diagram showing a constitution of in-line annealing apparatus according to an exemplary embodiment of the present invention; and

FIG. 9 is a flowchart showing a method of annealing a substrate using in-line annealing apparatus according to an exemplary embodiment of the present invention.

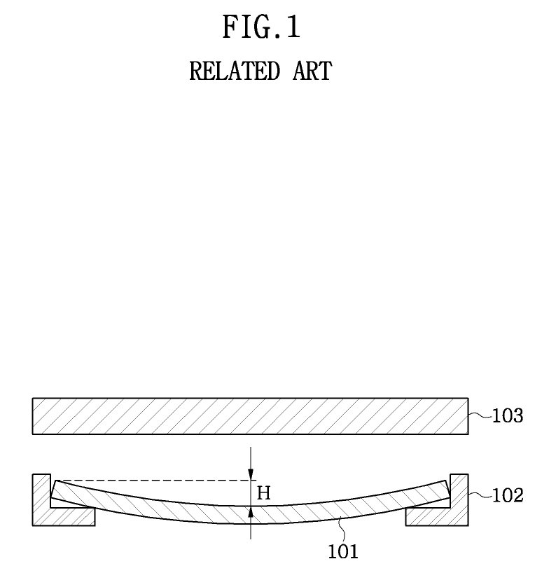

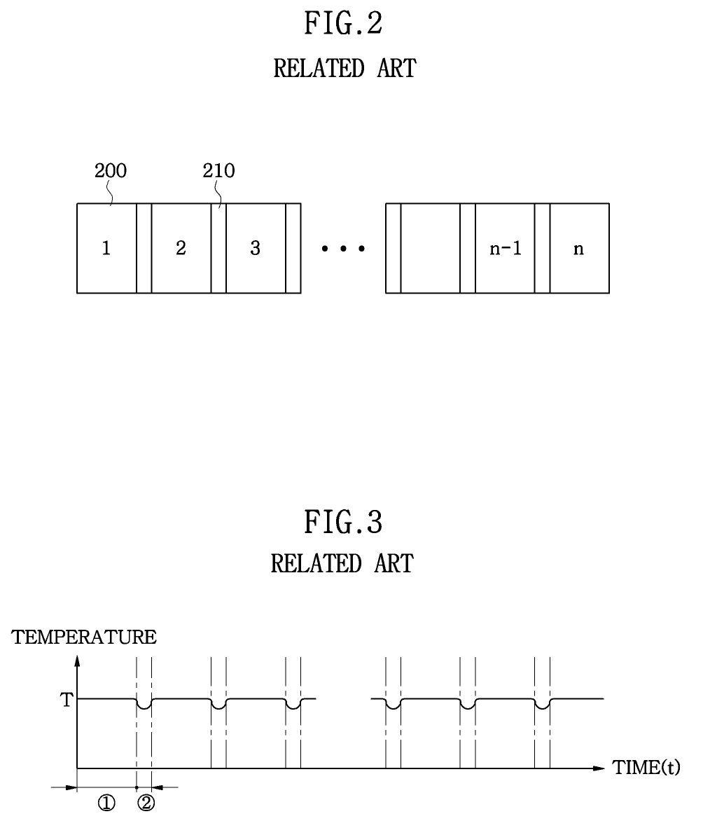

### DETAILED DESCRIPTION OF THE EMBODIMENTS

Reference will now be made in detail to exemplary embodiments of the present invention, examples of which are shown in the accompanying drawings, wherein like reference numerals refer to like elements throughout. The embodiments are described below in order to explain the aspects of the present invention by referring to the figures.

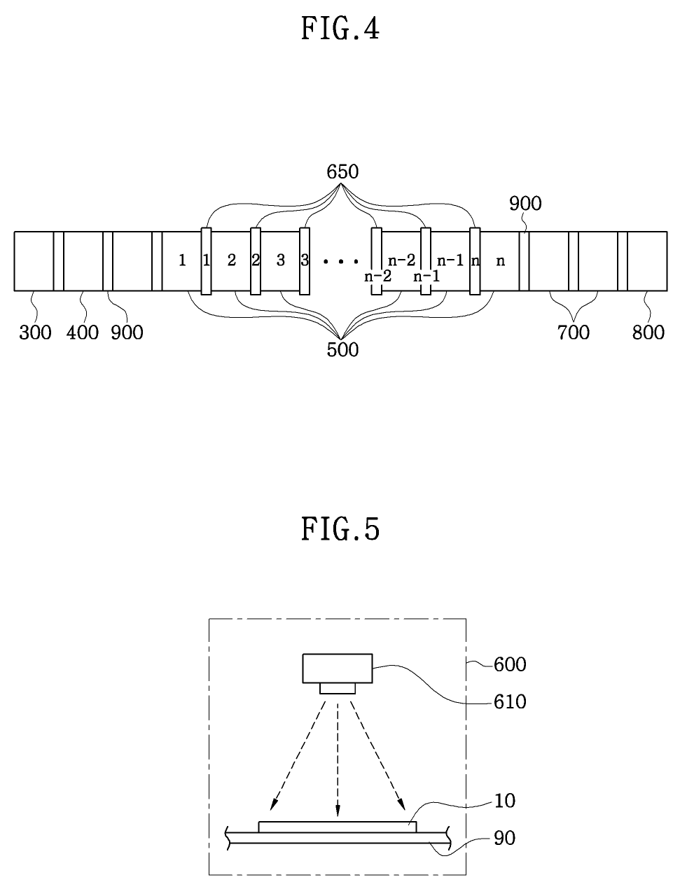

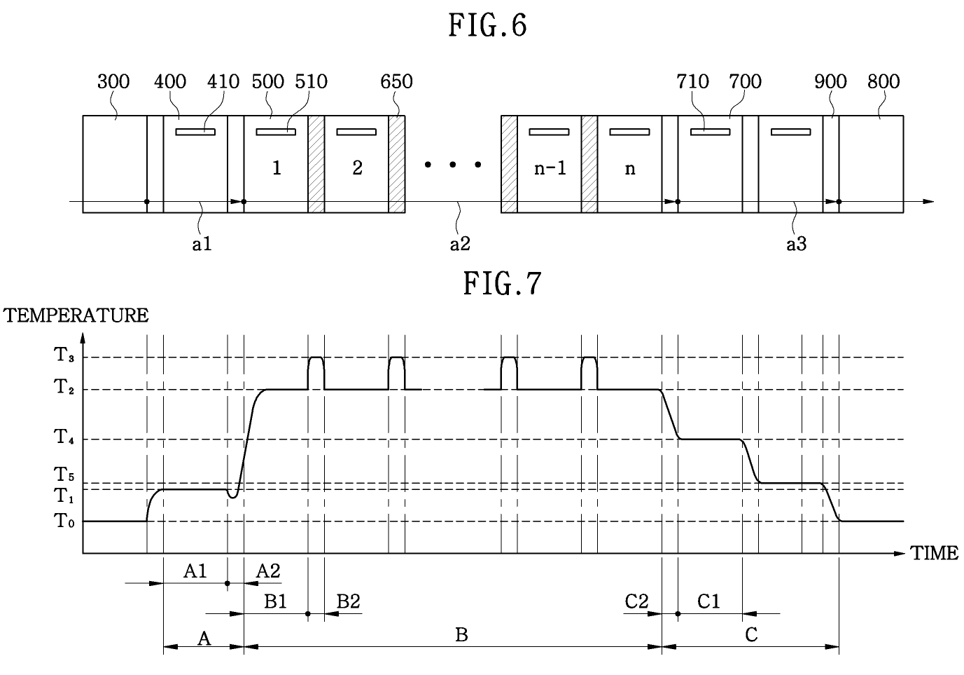

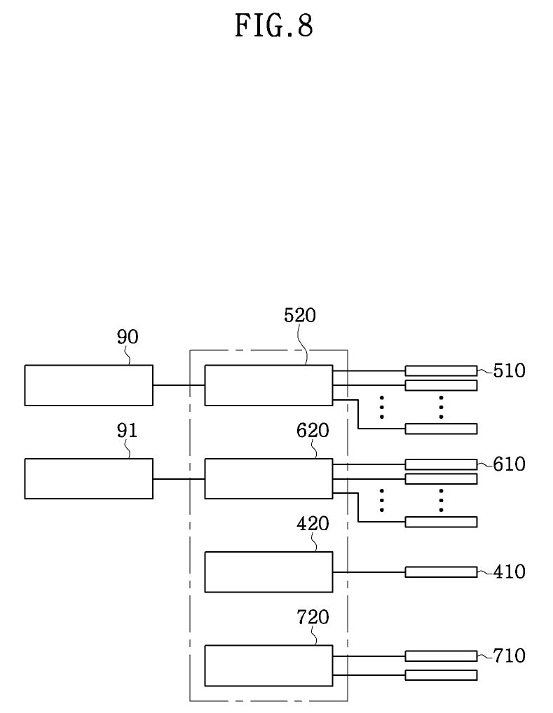

FIG. 4 is a block diagram of in-line annealing apparatus according to an exemplary embodiment of the present invention. FIG. 5 illustrates an instantaneous high-temperature annealing apparatus of FIG. 4. FIG. 6 is another block diagram of the in-line annealing apparatus of FIG. 4. FIG. 7 is a graph showing a temperature profile according to time for annealing a substrate in the in-line annealing apparatus of FIG. 4. FIG. 8 is a block diagram showing a constitution of in-line annealing apparatus according to an exemplary embodiment of the present invention.

Referring to FIGS. 4 and 7, the in-line annealing apparatus according to an exemplary embodiment of the present invention includes a plurality of heating devices 500 disposed in a line. The heating devices 500 comprise a heater 510 disposed therein, and a first controller 520 electrically connected with the heater 510 to control the temperature of the heater 510 as shown in FIG. 6. The first controller 520 controls operation of the heater 510 to heat a substrate 10 (and all layers disposed thereon) to a crystallization heating temperature T2 of FIG. 7. Further, the first controller 520 may control operation of plural heaters 510, as shown in FIG. 8.

Instantaneous high-temperature annealing units 650 are installed between the heating devices 500. The instantaneous high-temperature annealing units 650 comprise an instantaneous high-temperature annealing apparatus 600, a heat source 610 installed in the instantaneous high-temperature annealing apparatus 600, and a second controller 620 ton control the temperature of the heat source 610 as shown in FIG. 6. The second controller 620 controls operation of the heat source 610 to heat the substrate 10 to an instantaneous annealing temperature T3 of FIG. 7. The instantaneous annealing temperature T3 may be higher than the crystallization heating temperature T2 by a specific value. Further, the second controller 620 may control operation of plural heaters 610, as shown in FIG. 8.

Here, the heat source 610 may be an ultraviolet (UV) light source emitting UV light to the substrate 10. The UV light may have a short wavelength ranging from 200 nm to 400 nm.

A transportation path a2 through which the substrate 10 having a specific area is transported is formed, and a transportation device 90 of FIG. 5 for transporting the substrate 10 along the transportation path a2, such as a conveyor, is installed in the heating devices 500 and the instantaneous high-temperature annealing units 650.

Meanwhile, a preliminary heating device 400 that provides a substrate entry path a1 connected with the transportation path a2 is installed on an outermost one of the heating devices 500, i.e., a first heating device 500. The preliminary heating device 400 comprises a preliminary heater 410, and a third controller 420 electrically connected with the preliminary heater 410 to control a preliminary heating temperature T1 of the preliminary heater 410. Here, the preliminary heating temperature T1 may be lower than the crystallization heating temperature T2 by a specific value. Although not shown, the third controller 420 may control operation of plural preliminary heaters 410.

One or more follow-up cooling devices 700 that provide a substrate exit path a3 connected with the transportation path a2 are installed on the other outermost one of the heating devices 500, i.e., an n-th heating device 500. The follow-up cooling devices 700 comprise a cooling heater 710 to cool the substrate 10, and a fourth controller 720 to control the cooling heater 710 to have a temperature lower than the crystallization heating temperature T2 and the preliminary heating temperature T1 by specific values. Further, the fourth controller 720 may control operation of plural cooling heaters 710 as shown in FIG. 8.

A substrate loader 300 that guides the substrate 10 to the substrate entry path a1 is disposed on the side of the preliminary heating device 400 opposite the first heating device 500. A substrate unloader 800 to remove the cooled substrate 10 from the substrate exit path a3 is disposed on the side of the follow-up cooling devices 700 opposite the n-th heating device 500.

In addition, a buffer 900 is installed between the substrate loader 300 and the preliminary heating device 400 and between the preliminary heating device 400 and the first heating device 500. The buffer 900 is also installed between the n-th heating device 500 and the follow-up cooling devices 700 and between the follow-up cooling devices 700 and the substrate unloader 800. The transportation device 90 of FIG. 5 may be installed in the buffers 900.

Additionally, there may be included in the in-line annealing apparatus single or plural substrate loaders 300, preliminary heating devices 400, heating devices 500, instantaneous high-temperature annealing units 650, cooling devices 700, substrate unloaders 800, and/or buffers 900.

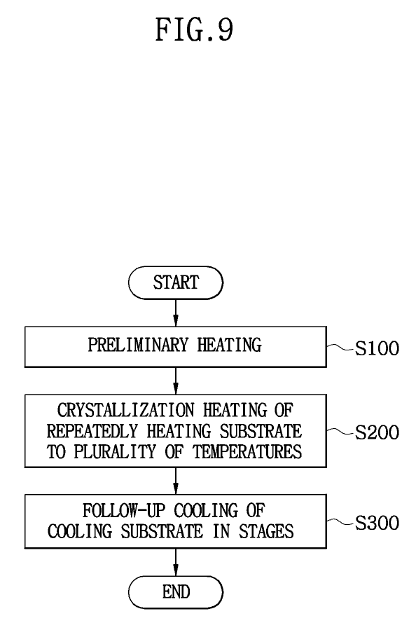

FIG. 9 is a flowchart showing a method of annealing a substrate using the in-line annealing apparatus according to an exemplary embodiment of the present invention. The method of annealing a substrate using the in-line annealing apparatus according to aspects of the present invention will be described below. Referring to FIGS. 6 to 9, the substrate 10 having a specific area is introduced into the substrate loader 300. Here, the temperature of the substrate 10 loaded into the substrate loader 300 is T0 of FIG. 7.

Subsequently, preliminary heating is performed (S100). The substrate 10 is introduced into the preliminary heating device 400 along the substrate entry path a1 by the transportation device 90, as shown in FIG. 5. The substrate 10 is heated in a preliminary heating section A. The preliminary heating section A may include a preliminary heating unit section A1 in which the substrate 10 is positioned in the preliminary heating device 400, and a buffer section A2 in which the substrate 10 taken out from the preliminary heating device 400 is introduced into the first heating device 500. Here, the third controller 420 operates the preliminary heater 410 to heat the substrate 10 to the preliminary heating temperature T1. Therefore, the substrate 10 positioned on the substrate entry path a1 may be heated to the preliminary heating temperature T1.

The buffer 900 is disposed between the substrate loader 300 and the preliminary heating device 400. Therefore, the substrate 10 transported from the substrate loader 300 to the preliminary heating device 400 through the buffer 900 can be gradually heated while forming a temperature profile inclined upward from T0 to T1.

Subsequently, crystallization heating is performed (S200). The substrate 10 heated to the preliminary heating temperature T1 is positioned by the transportation device 90 in the substrate transportation path a2 formed in the first heating device 500. Thus, the substrate 10 heated to the preliminary heating temperature T1 is heated in a crystallization heating section B. The crystallization heating section B may include crystallization heating unit sections B1 in which the substrate 10 is positioned in the heating devices 500, and instantaneous high-temperature annealing sections B2 between the crystallization heating unit sections B1.

Here, the first controllers 520 operate the heaters 510 to heat the substrate 10 to the crystallization heating temperature T2. Therefore, the substrate 10 is heated to the crystallization heating temperature T2 in the entire crystallization heating section B while passing through the plural heating devices 500. The crystallization heating temperature T2 may be about 600° C. to 700° C. The first controller 520 may further control the speed with which the transportation device 90 transports the substrate 10.

Here, the instantaneous high-temperature annealing units 650 installed between the heating devices 500 can prevent the substrate 10, which is heated to the crystallization heating temperature T2 while being transported along the substrate transportation path a2, from being cooled below the crystallization heating temperature T2. More specifically, the substrate 10 is heated to the crystallization heating temperature T2 in the first heating device 500, and may pass through the first instantaneous high-temperature annealing unit 650 while being transported to the second heating device 500. Therefore, the substrate 10 may be exposed in the instantaneous high-temperature annealing section B2.

The heating source 610, which is a UV light source, is installed in the instantaneous high-temperature annealing apparatuses 600 of the instantaneous high-temperature annealing unit 650 and may be controlled by the second controller 620. Therefore, the second controller 620 heats the substrate 10 transported from the first heating device 500 to the instantaneous annealing temperature T3 that is higher than the crystallization heating temperature T2 by a specific value, i.e., T3 is greater than 700° C. Further, the second controller 620 may further control the speed with which a second transportation device 91 transports the substrate 10 past the heat source 610. However, aspects of the present invention are not limited thereto such that the second transportation device 91 need not be included or may be controlled by the first controller 520. Moreover, each of the substrate loader 300, the preliminary heating devices 400, the heating devices 500, the instantaneous high-temperature annealing units 650, the cooling devices 700, the substrate unloader 800, and the buffers 900 may have independent transportation devices disposed therein which may be controlled independently by one or plural controllers.

Then, the substrate 10 whose temperature is corrected to the instantaneous annealing temperature T3 may be transported into the second heating device 500 and cooled to the crystallization heating temperature T2. And, the substrate 10 may be heated to the instantaneous annealing temperature T3 while passing through the second instantaneous high-temperature annealing unit 650. Therefore, the substrate 10 may be repeatedly heated a number of times in the crystallization heating unit sections B1 and the instantaneous high-temperature annealing sections B2 of the crystallization heating section B. Here, a time of the crystallization heating unit sections B1 is longer than a time of the instantaneous high-temperature annealing sections B2.

Therefore, when the substrate 10 is annealed while passing through the plural heating devices 500, the temperature of the substrate 10 remains above the crystallization temperature throughout the entire crystallization heating second B due to heating by the instantaneous high-temperature annealing units 650.

Subsequently, follow-up cooling is performed (S300). The substrate 10, having passed through the n-th heating device 500, is cooled in a cooling section C while passing through the follow-up cooling devices 700. The cooling section C may include a cooling section C1 and a cooling unit section C2 in which the substrate 10 is positioned in the follow-up cooling devices 700.

More specifically, the substrate 10 is positioned to be transported along the substrate exit path a3 in the first follow-up cooling device 700. Here, the fourth controller 720 operates the cooling heater 710 to cool the substrate 10 to a cooling temperature T4 lower than the crystallization heating temperature T2 by a specific value. Therefore, the substrate 10 may be cooled from the crystallization heating temperature T2 to the cooling temperature T4.

When the substrate 10 is transported from the n-th heating device 500 to the first follow-up cooling device 700, the substrate 10 passes through the buffer 900. Thus, the substrate 10 can be gradually cooled by the buffer 900 from the crystallization heating temperature T2 to the cooling temperature T4. The substrate 10 having passed through the first follow-up cooling device 700 is transported along the substrate exit path a3 and positioned in the second follow-up cooling device 700, and the fourth controller 720 operates the cooling heater 710 to cool the substrate 10 cooled to the cooling temperature T4 to a temperature T5 lower than the cooling temperature T4 by a specific value. When the substrate 10 is transported from the first follow-up cooling device 700 to the second follow-up cooling device 700, the substrate 10 passes through the buffer 900. Thus, the substrate 10 can be gradually cooled by the buffer 900 from the cooling temperature T4 to the temperature T5. Although T5 is shown in FIG. 7 to be higher than T1, aspects of the present invention need not be limited thereto such that T5 maybe lower than T1. Therefore, the substrate 10 can be gradually cooled through the entire cooling section C in stages.

Then, the substrate 10 having cooled to the temperature T5 may be introduced into the substrate unloader 800. Here, the substrate 10 may be cooled to the temperature T0 in the substrate unloader 800. When the substrate 10 is transported from the second follow-up cooling device 700 to the substrate unloader 800, the substrate 10 passes through the buffer 900. Thus, the substrate 10 can be gradually cooled by the buffer 900 from the temperature T5 to the temperature T0.

In addition, the buffer 900 through which the substrate 10 is transported is installed between the n-th heating device 500 and the follow-up cooling devices 700 and between the follow-up cooling devices 700, and a time for transporting the substrate 10 through the buffers 900 can be set shorter than the time of the instantaneous high-temperature annealing sections B2 using the buffers 900. Further, the buffer 900 may be disposed between the substrate unloader and the cooling devices 700.

As mentioned above, an exemplary embodiment of the present invention can heat the substrate 10 to the preliminary heating temperature T1 for a specific time, heat the substrate 10 heated to the preliminary heating temperature T1 to the crystallization heating temperature T2 and to the instantaneous annealing temperature T3 higher than the crystallization heating temperature T2 several times, and cool the substrate 10 to the cooling temperatures T4 and T5 in stages, thereby yielding the substrate 10.

In the entire crystallization heating section B, the substrate 10 is heated to the crystallization heating temperature T2 of about 600° C. to 700° C. Here, when the substrate 10 is heated to 700° C. or higher, defects can be reduced by atomic rearrangement, and it is possible to increase the density of nickel, etc., in polysilicon extracted from grain boundaries in the form of NiSiₓ (e.g., Ni₂Si, NiSi, and NiSi₂). In addition, the amount of nickel in the substrate 10 is reduced, such that electron mobility can be increased and leakage current can be reduced.

In the entire crystallization heating section B, the plural instantaneous high-temperature annealing sections B2, in which the substrate 10 is heated to the instantaneous annealing temperature T3 higher than the crystallization heating temperature T2 by a specific value, are included. Thus, the substrate 10 may not be cooled to its deformation temperature or below during the crystallization process.

In addition, the heat source 610 of the instantaneous high-temperature annealing units 650 disposed in the instantaneous high-temperature annealing sections B2 emits UV light having a short wavelength of 200 nm to 400 nm to the substrate 10 to anneal it, and thus may crystallize the substrate 10 with a smaller grain size in comparison with a conventional annealing furnace.

According to aspects of the present invention, when a substrate is heated while passing between heating devices disposed in a line, the temperature of the substrate is prevented from falling such that even a large-sized substrate can be prevented from being deformed.

In addition, a substrate is rapidly annealed above the deformation temperature of the substrate, that is, 700° C. or higher, between heating devices through which the substrate is transported, such that crystallinity can increase through high-temperature annealing, which is a factor of polysilicon crystallinity.

Furthermore, a substrate is instantly heated to a temperature higher than an annealing temperature by a specific value while being annealed at the high temperature, such that an annealing effect can be achieved. Thus, temperature deviation in the surface of the substrate is minimized, and uniform temperature can be obtained all over the surface. Consequently, it is possible to efficiently prevent a large-sized substrate from bending or deforming.

Moreover, a substrate transported along a transportation path is previously annealed to a preliminary heating temperature, again annealed to a crystallization heating temperature, and cooled in stages according to gradual cooling temperatures. Therefore, it is possible to stably perform an annealing process while maintaining characteristics of the annealed substrate.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. An in-line annealing apparatus, comprising:
a plurality of heating devices that provide a transportation path along which a substrate moves to heat the substrate to a crystallization temperature; and
an instantaneous high-temperature annealing unit disposed between two of the plurality of heating devices in the transportation path to heat the substrate to an instantaneous annealing temperature while the substrate is moved along the transportation path to an adjacent heating device.

2. The in-line annealing apparatus of claim 1, wherein the instantaneous high-temperature annealing unit comprises:
a plurality of heat sources disposed to heat the transported substrate to the instantaneous annealing temperature; and
a controller to control operation of the heat sources.

3. The in-line annealing apparatus of claim 1, wherein the instantaneous annealing temperature is higher than the crystallization temperature.

4. The in-line annealing apparatus of claim 1, wherein the crystallization temperature is 600° C. to 700° C.

5. The in-line annealing apparatus of claim 1, wherein the instantaneous annealing temperature is 700° C. or higher.

6. The in-line annealing apparatus of claim 1, wherein the substrate is heated at the crystallization temperature longer than heated at the instantaneous annealing temperature.

7. The in-line annealing apparatus of claim 1, further comprising:
a preliminary heating device disposed on one end of the heating devices to provide a substrate entry path connected to the transportation path and to maintain the substrate at a preliminary heating temperature lower than the crystallization temperature before the substrate enters the heating devices; and
a plurality of follow-up cooling devices disposed on the other end of the heating devices to provide a substrate exit path extending from the transportation path to maintain the substrate at cooling temperatures lower than the crystallization temperature upon exit of the substrate from the heating devices

8. The in-line annealing apparatus of claim 7, wherein the cooling devices each have a lower cooling temperature than an adjacent cooling device disposed closer to the heating devices.

9. The in-line annealing apparatus of claim 7, further comprising:
buffers, through which the substrate is transported, disposed between the preliminary heating device and the heating devices, between the heating devices and the follow-up cooling devices, and between the follow-up cooling devices,
wherein a time for transporting the substrate through the buffers is shorter than that of an instantaneous high-temperature annealing section.

10. The in-line annealing apparatus of claim 9, further comprising:
a substrate loader disposed opposite the preliminary heating device from the heating devices; and
a buffer disposed between the substrate loader and the preliminary heating device.

11. The in-line annealing apparatus of claim 10, wherein the buffer disposed between the substrate loader and the preliminary heating device heats the substrate to the preliminary heating temperature.

12. The in-line annealing apparatus of claim 9, wherein the buffer between the heating devices and the follow-up cooling devices cools the substrate to a first cooling temperature lower than the crystallization temperature, and the buffer between the follow-up cooling devices cools the substrate to a second cooling temperature lower than the first cooling temperature.

13. The in-line annealing apparatus of claim 1, wherein the instantaneous high-temperature annealing unit is an ultraviolet (UV) light.

14. The in-line annealing apparatus of claim 1, wherein the UV light has a wavelength of 200-400 nm.

15. A method of annealing a substrate using in-line annealing apparatus, comprising:
heating, using a preliminary heating device, a substrate introduced through a substrate entry path to a preliminary heating temperature;
repeatedly heating, using a plurality of heating devices and instantaneous high-temperature annealing units disposed between the heating devices, the substrate transported along a transportation path connected with the substrate entry path to a plurality of temperature higher than the preliminary heating temperature; and
cooling, using follow-up cooling devices, the substrate transported along a substrate exit path connected with the transportation path in stages to a temperature lower than the preliminary heating temperature.

16. The method of claim 15, wherein the repeatedly heating comprises:
heating, using the heating devices, the substrate to a crystallization temperature higher than the preliminary heating temperature; and
rapidly annealing, using the instantaneous high-temperature annealing units, the substrate positioned in the transportation path between the heating devices to an instantaneous annealing temperature higher than the crystallization temperature.

17. The method of claim 16, wherein the instantaneous high-temperature annealing units receive power from outside and heat the transported substrate to the instantaneous annealing temperature using a heat source disposed in a plurality of instantaneous high-temperature annealing apparatuses disposed between the heating devices along the transportation path.

18. The method of claim 17, wherein the heating devices provide a crystallization heating section in which the substrate is heated to the crystallization temperature for a specific time along the transportation path, the instantaneous high-temperature annealing apparatuses provide an instantaneous high-temperature annealing section in which the substrate is heated to the instantaneous annealing temperature for a specific time along the transportation path between the heating devices, and the time of the crystallization heating section is longer than the time of the instantaneous high-temperature annealing section.

19. The method of claim 15, wherein the heating comprises:
heating, using the preliminary heating device disposed on one end of the heating devices and providing the substrate entry path to be connected to the transportation path, the substrate introduced from outside to a preliminary heating temperature lower than the crystallization temperature.

20. The method of claim 15, wherein the cooling comprises:
cooling, using the follow-up cooling devices disposed on the other side of the heating devices and providing the substrate exit path extending from the transportation path, the substrate taken out to the substrate exit path to cooling temperatures lower than the crystallization temperature in stages.

21. The method of claim 19, further comprising:
transporting the substrate between the preliminary heating device and the heating devices, between the heating devices and the follow-up cooling devices, and between the follow-up cooling devices via buffers,
wherein a time for transporting the substrate through the buffers is shorter than a time for transporting the substrate through the instantaneous high-temperature annealing section.

22. The method of claim 16, wherein the crystallization temperature is about 600° C. to 700° C.

23. The method of claim 16, wherein the instantaneous annealing temperature is about 700° C. or higher.

24. An in-line annealing apparatus, comprising:
heating devices to heat a substrate to a crystallization temperature; and
instantaneous high-temperature annealing units disposed between the heating devices to heat the substrate to an instantaneous annealing temperature.

25. The in-line annealing apparatus of claim 24, wherein the crystallization temperature is about 600-700° C.

26. The in-line annealing apparatus of claim 24, wherein the instantaneous annealing temperature is greater than about 700° C.

27. The in-line annealing apparatus of claim 24, further comprising:
cooling devices to cool the substrate after heated by the heating devices and the instantaneous high-temperature annealing units.

28. The in-line annealing apparatus of claim 27, wherein the cooling devices cool the substrate to temperatures lower than the crystallization temperature in stages.

29 A method of annealing a substrate, comprising:
heating a substrate to a preliminary heating temperature;
repeatedly heating the substrate to a crystallization temperature higher than the preliminary heating temperature;
heating the substrate to an instantaneous annealing temperature higher than the crystallization temperature between the repeated heating of the substrate to the crystallization temperature; and
cooling the substrate to a cooling temperature less than the crystallization temperature.
